(19) United States
(12) Patent Application Publication
(10) Pub. No.: US 2015/0124775 A1
(43) Pub. Date: May 7, 2015

(54) METHOD AND APPARATUS FOR IMPROVING DEVICE-TO-DEVICE (D2D) DISCOVERY IN A WIRELESS COMMUNICATION SYSTEM

(71) Applicant: INNOVATIVE SONIC CORPORATION, Taipei City (TW)

(72) Inventor: Yu-Hsuan Guo, Taipei City (TW)

(21) Appl. No.: 14/528,484

(22) Filed: Oct. 30, 2014

Related U.S. Application Data
(60) Provisional application No. 61/898,648, filed on Nov. 1, 2013.

(51) Int. Cl. H04W 8/00; H04W 36/18; H04W 72/04

(52) U.S. Cl. CPC H04W 8/005; H04W 72/0426; H04W 36/18
USPC 370/331; 370/329

(57) ABSTRACT

A method and apparatus are disclosed for improving D2D discovery in a wireless communication system. The method includes receiving a resource allocation in a first cell. The method also includes performing a cell reselection to camp on a second cell. The method further includes informing the second cell about information of the resource allocation in the first cell.

### CROSS-REFERENCE TO RELATED APPLICATIONS

The present application claims the benefit of U.S. Provisional Patent Application Ser. No. 61/898,648 filed on Nov. 1, 2013, the entire disclosure of which is incorporated herein by reference.

### FIELD

This disclosure generally relates to wireless communication networks, and more particularly, to a method and apparatus for improving D2D (Device-To-Device) discovery in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure for which standardization is currently taking place is an Evolved Universal Terrestrial Radio Access Network (E-UTRAN). The E-UTRAN system can provide high data throughput in order to realize the above-noted voice over IP and multimedia services. The E-UTRAN system's standardization work is currently being performed by the 3GPP standards organization. Accordingly, changes to the current body of 3GPP standard are currently being submitted and considered to evolve and finalize the 3GPP standard.

### SUMMARY

A method and apparatus are disclosed for improving D2D discovery in a wireless communication system. The method includes receiving a resource allocation in a first cell. The method also includes performing a cell reselection to camp on a second cell. The method further includes informing the second cell about information of the resource allocation in the first cell.

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according to one exemplary embodiment.

FIG. 4 is a functional block diagram of the program code of FIG. 3 according to one exemplary embodiment.

FIG. 5 is a message flow diagram according to one exemplary embodiment.

FIG. 6 is a message flow diagram according to one exemplary embodiment.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A or LTE-Advanced (Long Term Evolution Advanced), 3GPP2 UMB (Ultra Mobile Broadband), WiMax, or some other modulation techniques.

In particular, the exemplary wireless communication systems devices described below may be designed to support one or more standards such as the standard offered by a consortium named “3rd Generation Partnership Project” referred to herein as 3GPP, including Document Nos. RP-122009, “Study on LTE Device to Device Proximity Services”; TR 22.803 V12.2.0, “Feasibility study for Proximity Services (ProSe)”; TR 23.703 V0.7.1, “Study on architecture enhancements to support Proximity-based Services (ProSe)”; R1-134877, “3GPP TR 36.843 V0.2.0, Study on LTE Device to Device Proximity Services-Radio Aspects”; R2-133699, “D2D RAN2 text proposal to RAN1 TR 36.843 with latest status after RAN2 #83bis”; TS 36.321 V11.3.0, “E-UTRA MAC protocol specification”; TS 36.304 V11.5.0, “E-UTRA UE procedures in idle mode”; and TS 36.331 V11.5.0, “E-UTRA RRC protocol specification”. The standards and documents listed above are hereby expressly incorporated by reference in their entirety.

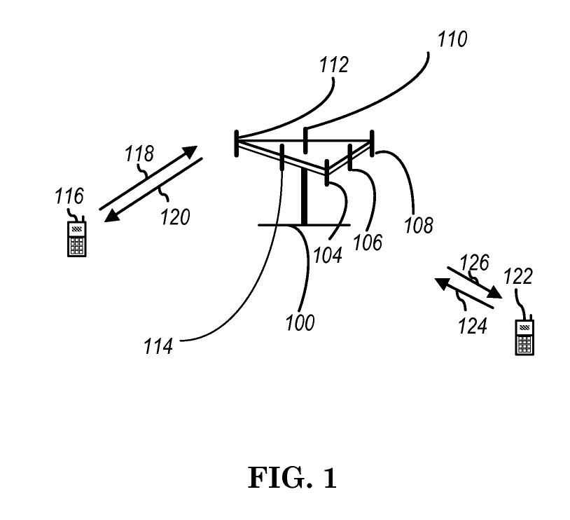

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal (AT) 122 is in communication with antennas 106 and 108, where antennas 106 and 108 transmit information to access terminal (AT) 122 over forward link 126 and receive information from access terminal (AT) 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage causes less interference to access terminals in neighboring cells than an access network transmitting through a single antenna to all its access terminals.

An access network (AN) may be a fixed station or base station used for communicating with the terminals and may also be referred to as an access point, a Node B, a base station, an enhanced base station, an evolved Node B (eNB), or some other terminology. An access terminal (AT) may also be called user equipment (UE), a wireless communication device, terminal, access terminal or some other terminology.

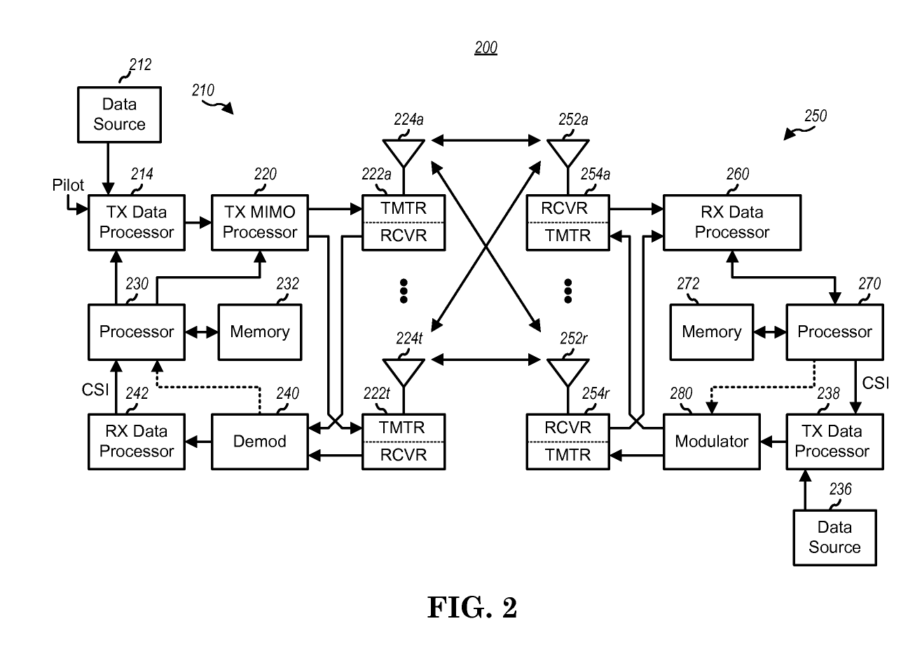

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

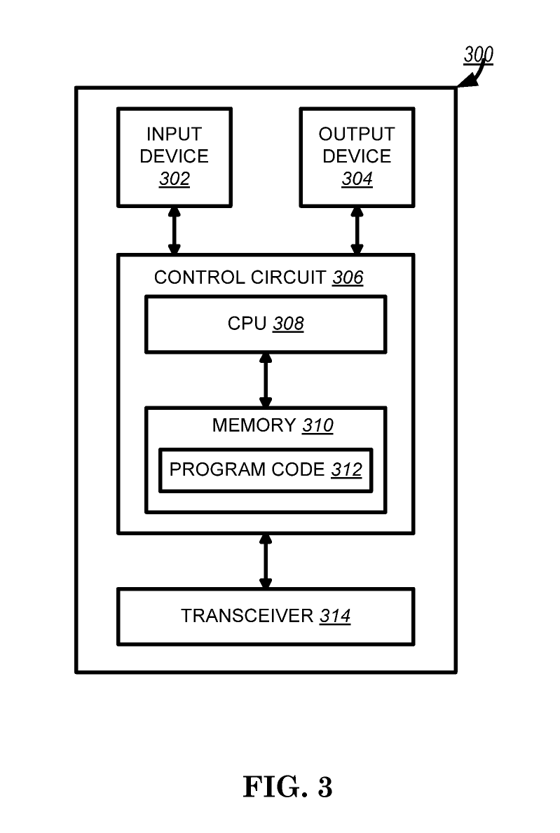

Turning to FIG. 3, this figure shows an alternative simplified functional block diagram of a communication device (which may be an access terminal or an access network) according to one embodiment of the invention. As shown in FIG. 3, the communication device 300 in a wireless communication system can be utilized for realizing the UEs (or ATs) 116 and 122 in FIG. 1 or the base station (AN) 100 in FIG. 1, and the wireless communications system is preferably the LTE system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

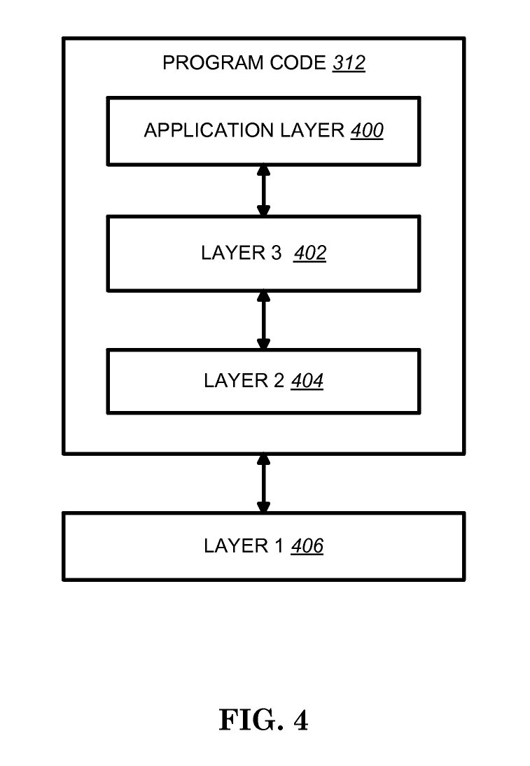

FIG. 4 is a simplified block diagram of the program code 312 shown in FIG. 3 in accordance with one embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

A study item for LTE Device to Device (D2D) Proximity Services (ProSe) has been approved based on 3GPP RP-122009 and the study is currently ongoing. Two proximity services, including Discovery and Direct Communication, would be evaluated in this study item. Scenarios to be focused on are discussed in 3GPP RP-122009 as follows:

### 4 Objective *

The objectives of this feasibility study are to evaluate LTE device-to-device proximity services, as follows:

| | | Outside network |
|---|---|---|
| | Within network coverage | coverage |
| Discovery | Non public safety & public | Public safety only |
| | safety requirements | |
| Direct Communication | At least public safety | Public safety only |
| | requirements | |

In particular:
[ . . . ]
3) Identify and evaluate options, solutions and enhancements to the LTE RAN protocols within network coverage [RAN2 primary, RAN3 secondary]:
a) to enable proximal device discovery among devices under continuous network management and control,
b) to enable direct communication connection establishment between devices under continuous network management and control,
c) to allow service continuity to/from the macro network
   [ . . . ]
   The identified options/enhancements should reuse the features of LTE as much as possible.

3GPP TR 22.803 V12.2.0 defines D2D discovery as follows:

ProSe Discovery: a process that identifies that a UE is in proximity of another, using E-UTRA.

3GPP TR 23.703 V0.7.1 describes two following different alternatives to realize D2D discovery:

ProSe direct discovery: A procedure employed by a ProSe-enabled UE to discover other ProSe-enabled UEs in its vicinity by using only the capabilities of the two UEs with rel.12 E-UTRA technology.
EPC-level ProSe discovery: a process by which the EPC determines the proximity of two ProSe-enabled UEs and informs them of their proximity.

Some potential requirements for ProSe Discovery are described in 3GPP TR 22.803 V12.2.0 as follows:

[PR.98] The operator shall be able to dynamically control the proximity criteria for ProSe discovery. Examples of the criteria include radio range and geographic range.
[ . . . ]
[PR.124] The operator network shall be able to continuously control the use of E-UTRAN resources for ProSe Discovery and ProSe Communication between UEs, as long as at least one of these UEs is under E-UTRAN coverage and using operator's spectrum.
[ . . . ]
[PR.77] ProSe services are available to ProSe-enabled UEs that are registered to a PLMN, and are under coverage of the E-UTRAN of said PLMN, potentially served by different eNBs. In this case E-UTRAN resources involved in ProSe services will be under real time 3GPP network control.

Currently, there are two possible radio resource allocations schemes for D2D Discovery described in 3GPP R1-134877 as follows:

### 5.1 Types of Discovery

At least the following two types of discovery procedure are defined for the purpose of terminology definition for use in further discussions/studies (note that these definitions are intended only to aid clarity and not to limit the scope of the study):
Type 1: a discovery procedure where resources for discovery signal transmission are allocated on a non UE specific basis
   Note: Resources can be for all UEs or group of UEs
Type 2: a discovery procedure where resources for discovery signal transmission are allocated on a per UE specific basis
   Type 2A: Resources are allocated for each specific transmission instance of discovery signals
   Type 2B: Resources are semi-persistently allocated for discovery signal transmission
      Note that further details of how the resources are allocated and by which entity, and of how resources for transmission are selected within the allocated resources, are not restricted by these definitions.

Also, the following agreements for D2D discovery have been made by RAN2 (as discussed in 3GPP R2-133699):
According to the RAN plenary prioritization, RAN2 will focus on a D2D ProSe discovery mechanism for in-coverage.
RAN2 should focus on the study of direct discovery.
UE needs to be allowed by the NW (Network) to transmit discovery messages in both RRC_IDLE and RRC_CONNECTED modes.
   The NW needs to be in control of the resources and transmission mode (RRC_CONNECTED and/or RRC_IDLE) that the UEs may use to transmit discovery signals.
It is possible for UEs to receive D2D discovery message while being RRC_IDLE and RRC_CONNECTED.
   If the UE cannot interpret (in AS (Access Stratum) or higher layers) the received D2D discovery message, the UE may or may not establish an RRC Connection in order to verify the content e.g. with an application server.
Transmission of discovery messages should be supported in RRC_IDLE mode and in RRC_CONNECTED.

In general, since it has been agreed that transmission of discovery signaling should be supported in RRC_IDLE, the remaining feasible radio resource allocation schemes for D2D discovery would be Type 1 and Type 2B:
For Type 1, available resource could be broadcasted. Therefore, both UEs in RRC_CONNECTED and RRC_IDLE could know the available resource and perform D2D discovery (such as in contention-based).
For Type 2B, after a UE acquires resource allocated semi-persistently by a cluster head the UE could perform D2D discovery in RRC_IDLE with configured semi-persistent resource. In one embodiment, the cluster head could be a resource allocation controller, such as an eNB (evolved Node B), a relay node, or a UE.

Regarding Type 2B, the cluster head may not know when the UE does not need the semi-persistent resource anymore because the UE is in RRC_IDLE and interacts with other UEs directly. For resource efficiency, the cluster head should be aware of whether the resource is used in order to efficiently utilize the resource. Under the circumstances, one possible method is the UE informs the cluster head when the discovery service is terminated or when an event similar to a SPS (Semi-Persistent Scheduling) implicit release occurs (as discussed in 3GPP TS 36.321 V11.3.0).

However, the UE may be moving in RRC_IDLE and perform cell reselection (as discussed in 3GPP TS 36.304 V11.5.0) to decide which cell to camp on. When the D2D discovery is ongoing and the cell reselection procedure decides to camp on another cell, the UE may not have the chance to inform the original cluster head before camping on another cell. Then, the original cluster head would not know that the resource semi-persistently allocated to the UE would not be used anymore. In this scenario, radio resource utilization is not efficient.

In one embodiment, the general concept is that if a UE has been allocated a semi-persistent resource in a first cell, the UE would provide to a second cell the information about the semi-persistent resource allocated in the first cell after the UE performs cell reselection to camp on the second cell. Then, the first cell would know from the second cell that the UE does not need the semi-persistent resource anymore.

In another embodiment, a UE would receive a resource allocation in a first cell. Then, the UE would perform cell reselection to camp on a second cell. And the UE would inform the second cell about information of the resource allocation in the first cell.

In one embodiment, the UE may release and/or stop using the resource allocation after camping on the second cell. In another embodiment, the UE may enter connected mode to inform the information. For example, the UE may initiate a RRC connection establishment procedure upon camping on the second cell. And a D2D discovery service of the UE may keep ongoing when the UE moves from the first cell to the second cell.

In one embodiment, a second cluster head would receive, from a UE, information of a resource allocation from a first cluster head to the UE. And the second cluster head would inform the first cluster head about the information. Furthermore, the second cluster head may inform the first cluster head about an identification of the UE.

Moreover, the resource allocation may allocate a semi-persistent resource. The resource allocation may be used for D2D Discovery. The resource allocation may not be released by the UE due to entering idle mode.

Furthermore, the resource allocation could be used by the UE to transmit D2D discovery signaling (to other UE(s)). The resource allocation would be allocated or received when the UE is in RRC_CONNECTED (or connected mode). A RRC connection of the UE could be released after the semi-persistent resource is allocated. The semi-persistent resource generally means the resource is allocated by one signaling and could be used in multiple TTIs (Transmission Timing Interval) to transmit multiple new transmissions (e.g., the resource is available periodically). In addition, the resource allocation could be used in RRC_IDLE (or idle mode), e.g., for the UE to perform transmission. In addition, the resource allocation could be used by the UE in connected mode, e.g. for the UE to perform transmission.

More specifically, the information could include a value (e.g., a 1-bit value) to indicate that the resource has been allocated in previous camped on cell. The information could also include configuration of the resource (such as periodicity and/or allocation). In addition, the information could include an identification (such as an Evolved Cell Global Identifier as specified in 3GPP TS 36.331 V11.5.0) of the first cell. As discussed in 3GPP TS 36.331 V11.5.0, the information could be provided during a RRC connection establishment procedure. Alternatively, the information could be provided during a procedure to request an allocation of semi-persistent resource in the second cell. Alternatively, the information could be provided during a procedure to request a resource for D2D discovery (in the second cell). In one embodiment, the UE performs the cell reselection in RRC_IDLE (or idle mode).

In one embodiment, the first cell is controlled by the first cluster head, and could be an E-UTRA (Evolved Universal Terrestrial Radio Access) cell. Furthermore, the second cell is controlled by the second cluster head, and could be an E-UTRA cell. The cluster head could be an eNB, a UE, or a relay node.

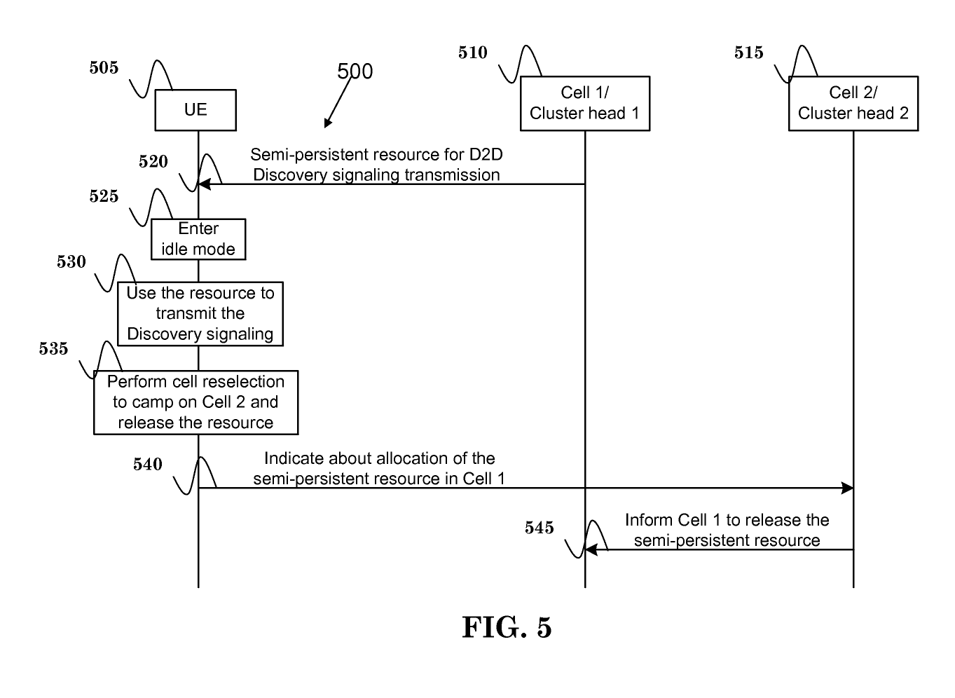

FIG. 5 is a message flow diagram 500 in accordance with one exemplary embodiment. In step 520, the UE 505 receives a transmission, allocating a semi-persistent resource for D2D discovery signaling transmission, from Cell 1/Cluster Head 1 510 while in connected mode. In step 525, the UE enters idle mode. In one embodiment, the semi-persistent resource is not released by the UE while the UE is entering idle mode. In step 530, the UE uses the semi-persistent resource to transmit a discovery signaling. In one embodiment, the UE uses the semi-persistent resource to perform transmission in idle mode or to perform transmission in connected mode.

In step 535, the UE performs cell reselection to camp on Cell 2/Cluster Head 2 515, and releases or the semi-persistent resource after camping on Cell 2/Cluster Head 2. In one embodiment, the UE initiates a RRC (Radio Resource Control) connection establishment procedure upon camping on Cell 2/Cluster Head 2. In one embodiment, the D2D discovery service of the UE keeps ongoing when the UE moves from Cell 1/Cluster Head 1 to Cell 2/Cluster Head 2.

In step 540, the UE informs Cell 2/Cluster Head 2 515 of the allocation of the semi-persistent resource in Cell 1/Cluster Head 1. In step 545, Cell 2/Cluster Head 2 provides (or informs) the information about the resource allocation to Cell 1/Cluster Head 1, and tells (or asks) Cell 1/Cluster Head 1 to release the semi-persistent resource. In one embodiment, the second cluster also informs Cell 1/Cluster Head 1 about the identification of the UE.

Referring back to FIGS. 3 and 4, in one embodiment, the device 300 includes a program code 312 stored in memory 310 of a UE. The CPU 308 could execute program code 312 to enable the UE (i) to receive a resource allocation in a first cell, (ii) to perform a cell reselection to camp on a second cell, and (iii) to inform the second cell about information of the resource allocation in the first cell. In addition, the CPU 308 can execute the program code 312 to perform all of the above-described actions and steps or others described herein.

In an alternative embodiment, the device 300 includes a program code 312 stored in memory 310 of a second cluster head. The CPU 308 could execute program code 312 to enable the second cluster head (i) to receive, from a UE, information of a resource allocation that a first cluster head provides to the UE, and (ii) to provide, to the first cluster head, the information of the resource allocation. In addition, the CPU 308 can execute the program code 312 to perform all of the above-described actions and steps or others described herein.

In one embodiment, the general concept is that a cluster head would allocate a semi-persistent resource to a UE, and would provide an expiration time of the semi-persistent resource to the UE. When the expiration time is reached, the UE would release or stop using the semi-persistent resource. The cluster head could then utilize the semi-persistent resource for other purposes.

In another embodiment, a UE would receive, from a cluster head, a resource allocation and an expiration time of the resource allocation. And the UE would use the resource allocation to perform transmission and stop using the resource allocation to perform transmission after the expiration time. The expiration time may be received when the UE is in connected mode. The expiration time may be received before receiving the resource allocation. Alternatively, the expiration time and the resource allocation may be received in a same signaling.

In one embodiment, if a service (e.g., a D2D discovery service) using the resource allocation is still ongoing, the UE may initiate a procedure used to request a resource for the service due to the expiration time is reached. Alternative, if a service (e.g., a D2D discovery service) using the resource allocation is still ongoing, the UE may initiate a RRC connection establishment procedure due to the expiration time is reached. In another embodiment, the UE may release and/or stop using the resource allocation after performing cell reselection to camp on another cell.

In one embodiment, a cluster head would transmit, to a UE, a resource allocation and an expiration time of the resource allocation to control when the UE is allowed to use the resource allocation to perform transmission. The expiration time may be transmitted when the UE is in connected mode. And the expiration time may be transmitted before receiving the resource allocation. Alternatively, the expiration time and the resource allocation may be transmitted in a same signaling. The cluster head may release the resource allocation upon the expiration time is reached.

Moreover, the resource allocation may allocate a semi-persistent resource. The resource allocation may be used for D2D Discovery. The resource allocation may not be released by the UE due to entering idle mode.

Furthermore, the resource allocation could be used by the UE to transmit D2D discovery signaling (to other UE(s)). In addition, the resource allocation would be allocated or received when the UE is in RRC_CONNECTED (or connected mode). Also, a RRC connection of the UE could be released after the semi-persistent resource is allocated. In general, the semi-persistent resource means the resource is allocated by one signaling and could be used in multiple TTIs to transmit multiple new transmissions (e.g., the resource is available periodically). The resource allocation could be used by the UE in RRC_IDLE (or idle mode), e.g., for the UE to perform transmission. In addition, the resource allocation could be used by the UE in connected mode, e.g., for the UE to perform transmission.

Furthermore, the expiration time could indicate a number of times being allowed to use the semi-persistent resource to perform new transmissions. Alternatively, the expiration time could indicate a number of possible chances to use the resource allocation to perform new transmissions. Alternatively, the expiration time could indicate a number of periodicity or cycle the resource allocation is allowed to be used. The expiration time could also indicate a length of a timer used to decide whether the semi-persistent resource is allowed to be used. Then, the UE could release the semi-persistent resource upon the number is reached or the timer expires. The expiration time could be provided to the UE before allocating the semi-persistent resource. Alternatively, the expiration time and the semi-persistent resource could be provided by a same signaling. In one embodiment, the cluster head could be an eNB, UE, or relay node.

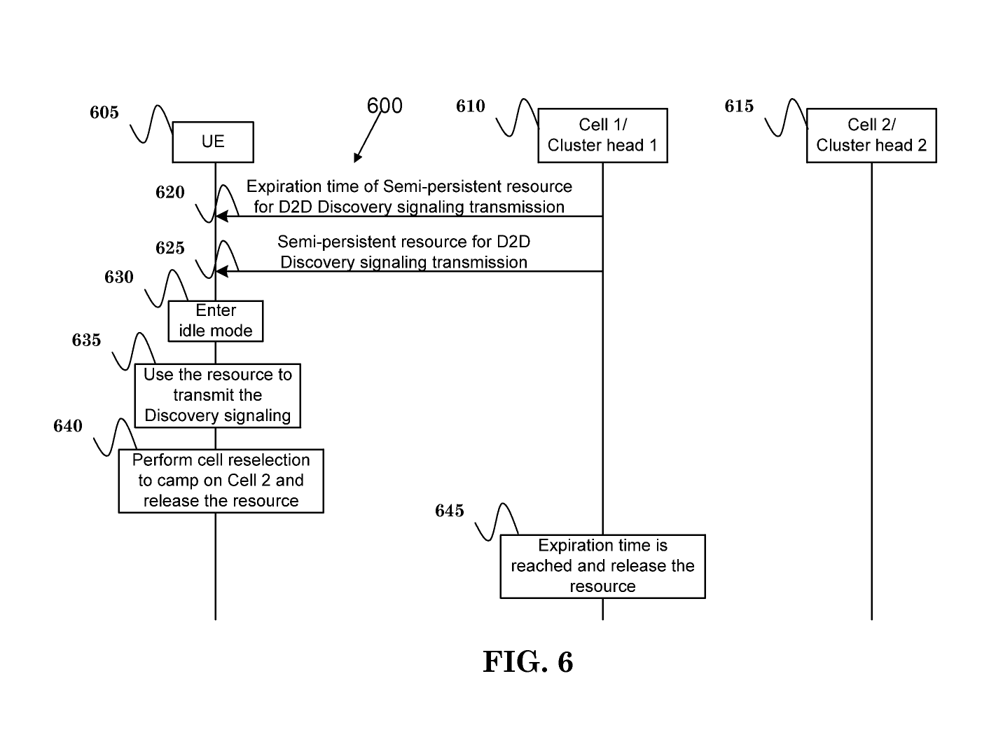

FIG. 6 is a message flow diagram 600 in accordance with one exemplary embodiment. In step 620, while in connected mode, the UE 605 receives a transmission providing an expiration time for a semi-persistent resource allocated for D2D discovery signaling transmission from Cell 1/Cluster Head 1 610. In step 625, while in connected mode, the UE receives a transmission allocating a semi-persistent resource for D2D discovery signaling transmission from Cell 1/Cluster Head 1. In step 630, the UE enters idle mode. In one embodiment, the resource allocation is not released by the UE when the UE enters idle mode. In step 635, the UE uses the semi-persistent resource to transmit a discovery signaling.

In step 640, the UE performs cell reselection to camp on Cell 2/Cluster Head 2 615, and releases or stops using the semi-persistent resource after camping on Cell 2/Cluster Head 2. In step 645, Cell 1/Cluster Head 1 releases the semi-persistent resource after the expiration time has been reached.

Referring back to FIGS. 3 and 4, in one embodiment, the device 300 includes a program code 312 stored in memory 310 of a UE. The CPU 308 could execute program code 312 to enable the UE (i) to receive, from a cluster head, a resource allocation and an expiration time for the resource allocation, and (ii) to use the resource allocation to perform transmission and stop using the resource allocation to perform transmission after the expiration time. In addition, the CPU 308 can execute the program code 312 to perform all of the above-described actions and steps or others described herein.

In another embodiment, the device 300 includes a program code 312 stored in memory 310 of a cluster head. The CPU 308 could execute program code 312 to enable the cluster head to transmit, to a UE (User Equipment), a resource allocation and an expiration time of the resource allocation to control when the UE is allowed to use the resource allocation to perform transmission. In addition, the CPU 308 can execute the program code 312 to perform all of the above-described actions and steps or others described herein.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects concurrent channels may be established based on pulse repetition frequencies. In some aspects concurrent channels may be established based on pulse position or offsets. In some aspects concurrent channels may be established based on time hopping sequences. In some aspects concurrent channels may be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

1. A method for improving D2D (Device-to-Device) discovery in a UE (User Equipment) of a wireless communication system, comprising:
receiving a resource allocation in a first cell;
performing a cell reselection to camp on a second cell; and
informing the second cell about information of the resource allocation in the first cell.

2. The method of claim 1, further comprising:
the UE releases and/or stops using the resource allocation after camping on the second cell.

3. The method of claim 1, wherein the information of the resource allocation is provided during a RRC (Radio Resource Control) connection establishment procedure, or during a procedure used to request a resource for D2D discovery in the second cell.

4. The method of claim 1, further comprising:
the UE initiates a RRC (Radio Resource Control) connection establishment procedure upon camping on the second cell.

5. The method of claim 1, wherein a D2D discovery service of the UE keeps ongoing when the UE moves from the first cell to the second cell.

6. The method of claim 1, wherein the resource allocation is to allocate a semi-persistent resource.

7. The method of claim 1, wherein the resource allocation is used for D2D discovery.

8. The method of claim 1, wherein the resource allocation is not released by the UE due to entering idle mode.

9. The method of claim 1, wherein the information includes configuration of the resource or an identification of the first cell.

10. A method for improving D2D (Device-to-Device) discovery in a UE (User Equipment) of a wireless communication system, comprising:
receiving, from a cluster head, a resource allocation and an expiration time for the resource allocation;
using the resource allocation to perform transmission; and
stopping using the resource allocation to perform transmission after the expiration time.

11. The method of claim 10, wherein the expiration time is received before receiving the resource allocation, or the expiration time and the resource allocation are received in a same signaling.

12. The method of claim 10, further comprising:
the UE initiates a procedure used to request a resource for a service or a RRC (Radio Resource Control) connection establishment procedure due to the expiration time is reached if the service (such as a D2D discovery service) using the resource allocation is still ongoing.

13. The method of claim 10, wherein the resource allocation is to allocate a semi-persistent resource.

14. The method of claim 10, wherein the resource allocation is used for D2D discovery.

15. The method of claim 10, wherein the UE uses the resource allocation to perform transmission in idle mode.

16. The method of claim 10, wherein the resource allocation is not released by the UE due to entering idle mode.

17. The method of claim 10, wherein the expiration time indicates a number of possible chances to use the resource allocation to perform new transmissions.

18. The method of claim 10, wherein the expiration time indicates a number of periodicity or cycle the resource allocation is allowed to be used.

19. The method of claim 10, wherein the expiration time indicates a length of a timer which is used to decide whether the semi-persistent resource is allowed to be used.

20. A communication device for improving D2D (Device-to-Device) discovery in a UE (User Equipment) of a wireless communication system, the communication device comprising:
a control circuit;
a processor installed in the control circuit;
a memory installed in the control circuit and operatively coupled to the processor;
wherein the processor is configured to execute a program code stored in the memory to improve D2D discovery by:
receiving, from a cluster head, a resource allocation and an expiration time for the resource allocation;
using the resource allocation to perform transmission; and
stopping using the resource allocation to perform transmission after the expiration time.
